(19) United States
(12) Patent Application Publication
(10) Pub. No.: US 2023/0168475 A1
(43) Pub. Date: Jun. 1, 2023

(54) ANTI-BLUR INFRARED LENS FOR PANORAMIC CAMERA SYSTEM USING HD RESOLUTION SENSOR

(71) Applicant: VIETTEL GROUP, Ha Noi City (VN)

(72) Inventors: Van Dat Nguyen, Thai Binh Province (VN); Xuan Du Dang, Pho Yen Town (VN); Thanh Dat Vu, Ha Noi City (VA)

(73) Assignee: VIETTEL GROUP, Ha Noi City (VN)

(21) Appl. No.: 18/060,236

(22) Filed: Nov. 30, 2022

(30) Foreign Application Priority Data
Nov. 30, 2021 (VN) 1-2021-07679

(51) Int. Cl. G02B 13/14; G02B 17/08; G02B 9/64; G02B 13/18

(52) U.S. Cl. CPC G02B 13/14; G02B 17/0804; G02B 9/64; G02B 13/18

(57) ABSTRACT

The disclosure refers to the anti-blur infrared lens for the panoramic camera system, also known as Infrared Search and Track (IRST), using a 1280×1024 resolution sensor with a working F-number of 2. The lens operates in the mid-infrared wavelength range of 3-5 μm, using a fast steering mirror (FSM) and a pair of lenses with extended polynomial surfaces to prevent image blur during integration time. The optical image captured by the lens always maintains sharpness during the change of rotation angle of the device by changing the angular position of FSM. The lens is capable of observing with wide angle-of-view and large rotation angle compensation ability, ensuring long detection distance.

### TECHNICAL FIELD

The present invention relates to an anti-blur infrared lens for a panoramic camera system using HD resolution sensor. To be specific, the anti-blur infrared lens for the panoramic camera system using the HD resolution sensor mentioned in the invention is applied in electro-optical systems, thermal imaging systems for search and surveillance applications on civilian and military equipment.

### TECHNICAL STATUS OF THE INVENTION

Along with the development of infrared imaging technology, the demand for optical systems using high-quality thermal images is increasing dramatically. The ability to observe in extreme environmental conditions with limited visibility such as night time or environments with smoke, dust, and fog makes infrared lenses, especially ones operate in the mid-wave infrared spectral region, play an extremely important role and indispensable component in search and surveillance systems in the military as well as civilian applications.

Infrared lenses with anti-blur capabilities has become an integral component in panoramic surveillance electro-optical systems, giving these systems good visibility in both stationary mode and continuous scanning mode.

Recently, there have been many inventions of optical systems at mid-infrared wavelengths used for surveillance systems, especially the IRST panoramic camera system. Most of these inventions meet the requirements of technical specifications, structure and image quality, yet there are still many limitations in terms of applicability. Specifically, in U.S. Pat. No. 9,482,853, the design uses three large asymmetrical mirrors to create the magnification of the lens. This makes manufacturing and assembling difficult because the position of the mirrors requires extremely high accuracy. In another patent, U.S. Ser. No. 10/690,903, a design uses up to fifteen lens elements and one prism element to accommodate image blur compensation. However, with a large number of elements, it leads to the low transmission, reducing the visibility of the device. In another invention of this type of lens, the optical structure is compatible with a 1280×720 resolution sensor, but the field of view per frame is only less than 3° in each direction, making the viewing angle of the device small and unsuitable for a panoramic surveillance device. Another drawback of this invention is that the maximum compensation angle of the mirror is only 1.2°, making it difficult for the surveillance system to achieve the desired high updating speed.

From these information, coupling with the knowledge and experience in designing optical lenses, the authors propose an anti-blur infrared lens for the IRST panoramic camera system using the HD resolution sensor. This invention meets the rigorous requirements in terms of the specifications, while also solving the above mentioned limitations. Specifically, the lens is designed with a folding structure that uses a scanning mirror to compensate for the line-of-sight of the device when the camera module is acquiring images, ensuring image stability. This lens has a per-frame field of view of up to 10°×8° and is capable of responding to mirror compensation angles of up to 2° with a system update frequency of up to 360°/s. In addition, the lens uses a second folding mirror to ensure the layout space of the sensor inside the size of the lens, providing compactness for the design. In this invention, a pair of lenses with extended polynomial surfaces are simulated, calculated and selected to be used to reduce the effect of image wander with the greatest efficiency, so that the image quality is maintained throughout the exposure time of the sensor. Image wander is the phenomenon in which the image of the fields in the boundary region are moved when the system is scanning and the mirror changes the flip angle; Although the image centre area is kept fixed on the image plane, the image positions in the boundary area are changed causing the image quality to deteriorate during the scanning process. This phenomenon becomes more severe and causes more blurriness as the device rotation speed and field of view per frame increase.

The above problem has been minimized almost completely with the successful research and design of an infrared anti-blur lens for the IRST panoramic camera system using an HD resolution sensor, specifically a cooling sensor with a working F-number of 2, a resolution of 1280×1024 pixels and a pixel pitch of 15 μm.

### TECHNICAL NATURE OF THE INVENTION

The purpose of the present invention is to propose an anti-blur thermal imaging lens for camera scanning systems using HD resolution sensor with a large aperture. The structure of the lens from the object plane to the image plane consists of five main groups, therein:

An external lens group (G1) consists of six lens elements with the task of receiving an incident parallel beam, creating an image in the intermediate plane, and transforming the outgoing beam to be afocal with a fixed magnification.

A fast steering mirror group (M1) stabilizes the direction of light rays after reflecting through the mirror.

A converging lens group (G2) creates a second intermediate image.

A second fixed mirror group (M2) changes the direction of the beam at an angle of 45°, making the lens structure compact.

An intermediate magnification group (G3) magnifies the image from the intermediate image to the sensor.

The folding structure of the lens is achieved by using two reflectors with an average reflectance ratio in the wavelength range of approximately 98%. The first mirror is a fast steering mirror used to help the lens maintain the line-of-sight as the device scans. The second mirror makes it possible for the cooling sensor to be compactly arranged, making the lens housing size smaller.

According to this structure, the ratio of the focal length of the whole lens to the focal length of the imager group is exactly equal to the magnification ratio of the afocal magnifier according to the calculation f(lens)=f(imager group)×magnification ratio.

According to this structure, the magnifying lens group has the effect of magnifying the angle of the light beam into the lens while preserving the “afocal” nature of the outgoing light beam.

According to this structure, the lens uses a fast steering mirror to maintain the line-of-sight of the device. The lens is optimized to accommodate an angle of change up to 2° at a scanning speed of 360°/s, ensuring that during the operation, the image sharpness is maintained in scanning mode or rest mode.

According to this structure, the displacement of lens 8 is used for active focus and thermal compensation in the temperature range of −20÷65° C. and focusing distance from 20 m to infinity.

According to this structure, the lens uses a group of two lenses 3 and 4 with extended polynomial surfaces, making the lens resistant to image blur when the device is scanning at high speed.

According to this structure, the distance from the exit pupil of the lens to the sensor and the diameter of the exit pupil are set to match the parameters of common commercial high-definition detectors on the market. To ensure that the lens is compatible with cooling sensors with a working F-number of 2, the ratio between the distance from the exit pupil of the lens to the sensor and the diameter of the exit pupil is less than 2.

The lens design uses several aspheric surfaces and hybrid aspherical-diffractive surfaces to increase optical quality, reducing the total number of elements required in the lens design.

According to this structure, the anti-blur infrared lens for the IRST panoramic camera system uses an HD resolution sensor to collect infrared radiations within the wavelength range of 3-5 μm and focus on the sensor with a resolution of 1280×1024 and a working F-number of 2, creating clear images in every field of view of the device and at any compensation angle of the mirror in the field of view.

### BRIEF DESCRIPTION OF FIGURES

FIG. 1 illustrates the optical structure of the lens, consisting of 10 lenses designated from L1 to L10 respectively with two reflectors (M1), (M2);

FIG. 2 illustrates the optical structure of the lens including surfaces from S1 to S23;

FIG. 3 illustrates the RMS value of angular spot radius of the light beam after passing through the lens group from L1 to L6;

FIG. 4 illustrates the spot radius on the sensor surface at the position of the mirror rotating at angle of 0;

FIG. 5 is a graph illustrating the modulation transfer function of the lens at the position of the mirror rotating at angle of 0;

FIG. 6 illustrates distortion value on the image plane;

FIG. 7 illustrates the spot radius on the image plane at the mirror positions corresponding to each rotation angles of the device;

FIG. 8 illustrates how the rotating mirror compensates for the rotation angle of the device;

FIG. 9 illustrates the spot radius on the image plane at all mirror positions on the same reference frame corresponding to the design using the anti-blur method;

FIG. 10 illustrates the spot radius on the image plane at all mirror positions on the same reference frame corresponding to a design without anti-blur method;

FIG. 11 is a graph describing the relationship between the window and the diameter of the sensor so that the lens is compatible with the F/#2 detectors.

### DETAILED DESCRIPTION OF THE OPTIONS OF THE INVENTION

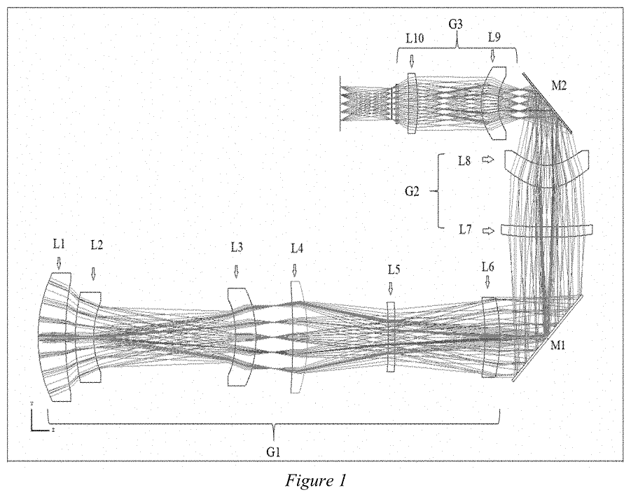

The invention of an anti-blur infrared lens for an anti-blur scanning system using an HD resolution sensor whose structure is illustrated in FIG. 1 with ten main lenses, two reflector mirrors. In particular, in the direction from the object plane to the image plane, the lens includes: lenses (L1), (L2), (L3), (L4), (L5), (L6) forming the magnification group (G1), fast steering mirror group (M1), lenses (L7), (L8) forming the converging lens group (G2), fixed mirror group (M2), lenses (L9), (L10) forming the intermediate image magnification group (G3).

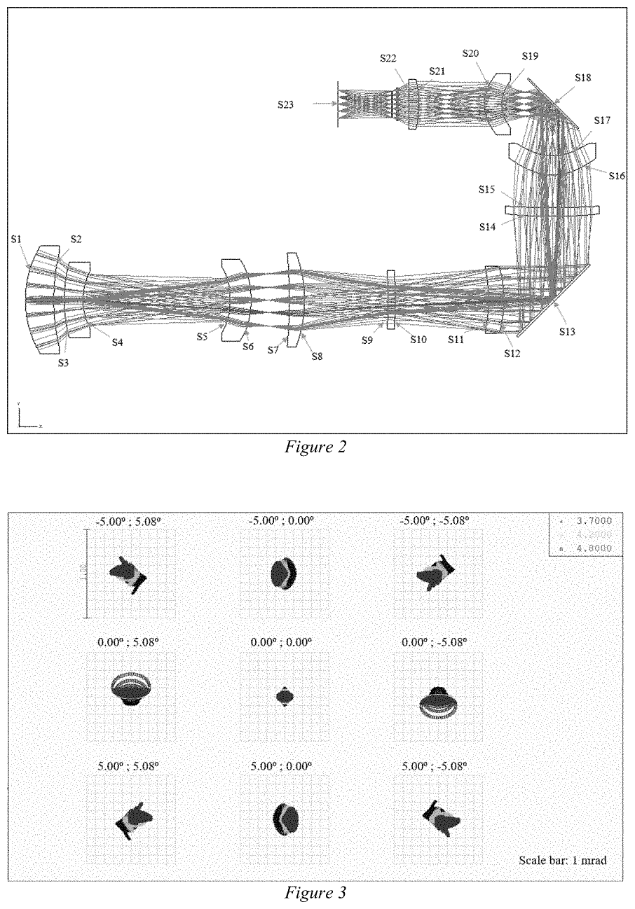

Referring to FIG. 1, FIG. 2, a group of three lenses (L1), (L2), (L3) consists of two lenses (L1) and (L2) with positive power and one lens (L3) with negative power to form the first intermediate image plane. Accordingly, the focal length of the lens group generated by the elements (L1), (L2), (L3) has a satisfactory value of 200 mm>f (L1, L2, L3)>150 mm. The group of three lenses (L4), (L5), (L6) consists of two positive power lenses (L4, L6) combined with one negative power lens (L5) to convert the intermediate image on the plane (P1) into parallel beams. The focal length of the lens group formed by the elements (L4), (L5), (L6) satisfies the following condition: 100 mm<f (L4, L5, L6)<150 mm.

According to this structure, the group (G1) has the effect of magnifying the focal length of the optical part created by the group (G2, G3) to a certain magnification ratio (A). In order to ensure the magnification of the group (G1), the focal ratio f(L1,L2,L3)/f(L4,L5,L6)=A. In addition, the magnification ratio is between 1.2 and 2.0 therefore 1.2≤f(L1,L2,L3)/f(L4,L5,L6)=A≤2.0.

Referring to FIG. 1, FIG. 2, the lenses (L3), (L4) are the ones responsible for anti-blur function when the system is scanning. The lens (L3) is made of germanium with a negative power, consists of a concave face (S5) with an aspherical profile and a convex surface (S6) with an extended polynomial surface facing towards the image plane. The lens (L4) is made of ZnSe with a negative power, consists of a concave surface (S7) with an extended polynomial profile and a convex surface (S8) with a spherical profile facing towards the image plane.

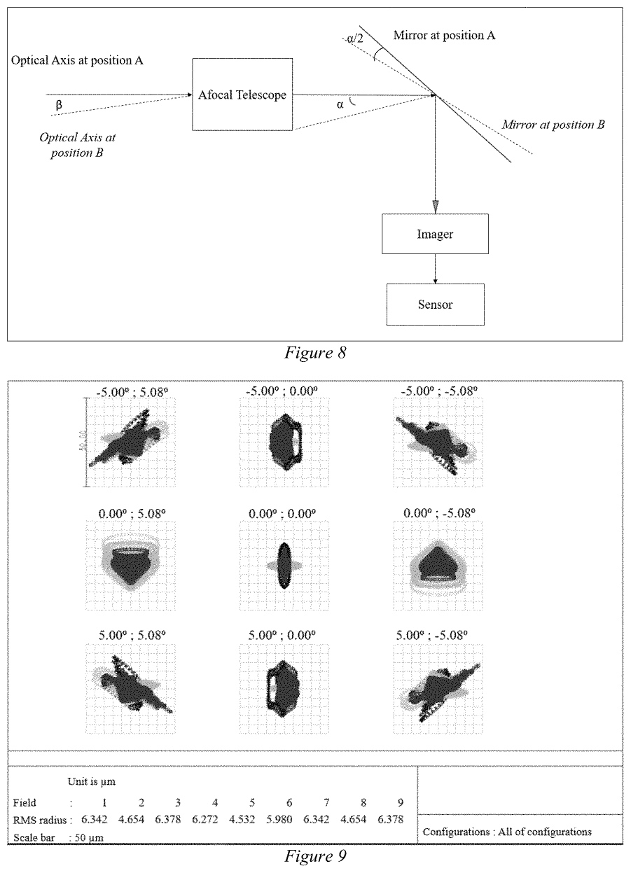

In conformity with this structure, referring to FIG. 1, FIG. 8, the mirror is positioned in the exit pupil position of the magnification group (G1) located between the lenses (L6) and (L7). This is the position of the entrance pupil of imager group, thereby ensuring that the mirror size for the FSM is not too large, reducing costs and minimizing motion control errors. Mirrors used for FSM are designed to satisfy the compensation of rotation angle of lens so that:

$$\{ \begin{matrix}α = β \times A / 2 \\ {1.8}^{0} \leq β\end{matrix}$$

In which α is the rotation angle of the mirror, β is the rotation angle of the device in the integration time for each frame, A is the magnification ratio of the group (G1).

FIG. 8 illustrates an example where the mirror (M1) combines with the group (G1) to compensate rotation angle of the lens in order to maintain the stability of the optical image.

Referring to FIG. 1, FIG. 2, the converging lens group (G2) consists of two positive focal lens elements (L7) and (L8) focusing the light beam coming out of the group (G1) to generate an intermediate image plane. The single lens element (L8) which helps the lens to have focusing capabilities in different object distances and temperatures, is made of silicon with a positive power and two curved surfaces of aspherical profiles. The focusing element helps the lens compensate the image sharpness at a distance from 20 m to infinity in the temperature range from −20° C. to 65° C.

Referring to FIG. 1, FIG. 2, the reflective mirror (M2) is located between elements (L8) and (L9) to create a double-folding structure for the lens. The position of the mirror is arranged not on the intermediate image plane but still keeps its compact size, ensuring that the image is not affected by dust or scratches on the mirror surface.

Referring to FIG. 3, the group (G1) is designed to perform the function of magnifying the angle of the incoming light beam, while maintaining the afocality when leaving the lens group. FIG. 3 shows that all radiations coming from infinity after passing through the group (G1) have good parallelism with a calculated RMS value to be lower than 0.136 mrad, which is equivalent to the instantaneous field of view (iFOV) at all positions of the declared configuration.

Referring to FIG. 1, FIG. 2, the intermediate magnification group (G3) is designed to magnify the intermediate image created by the converging lens group (G2). Accordingly, the image size magnification ratio is from 1.1 to 2.5, which is equivalent to:

1.1≤f(G1,G2,G3)/f(G1,G2)≤2.5

In which:

f(G1,G2,G3) is the focal length of an optical part formed by groups G1,G2,G3;

f(G1,G2) is the focal length of the optical part formed by groups G1,G2.

Referring to FIG. 11, the design has been optimized so that the used sensor has a diameter window D located directly in front of the sensor with a distance d. Accordingly, the ratio between the distance d and the diameter D has the value d/D<2, ensuring that the lens is compatible with F/#2 detectors.

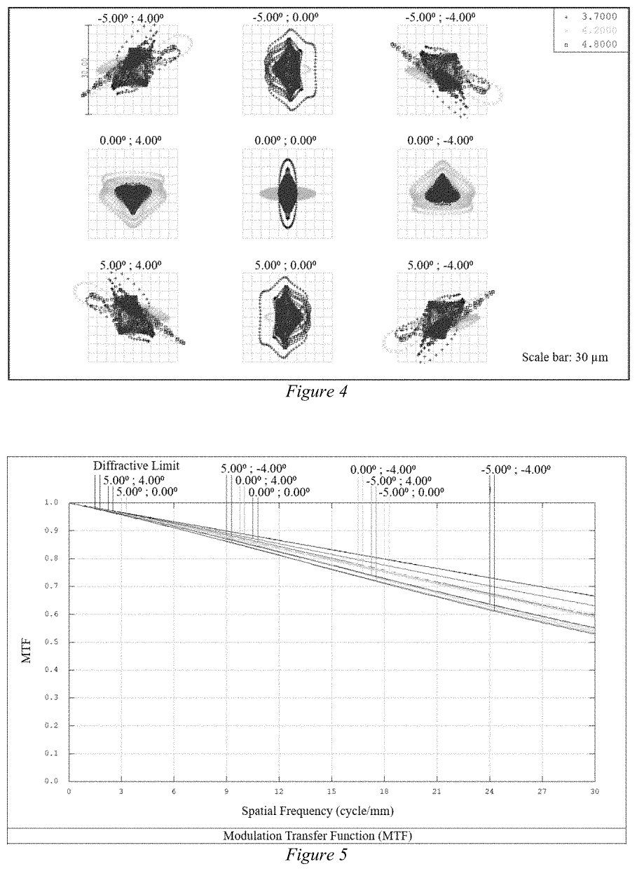

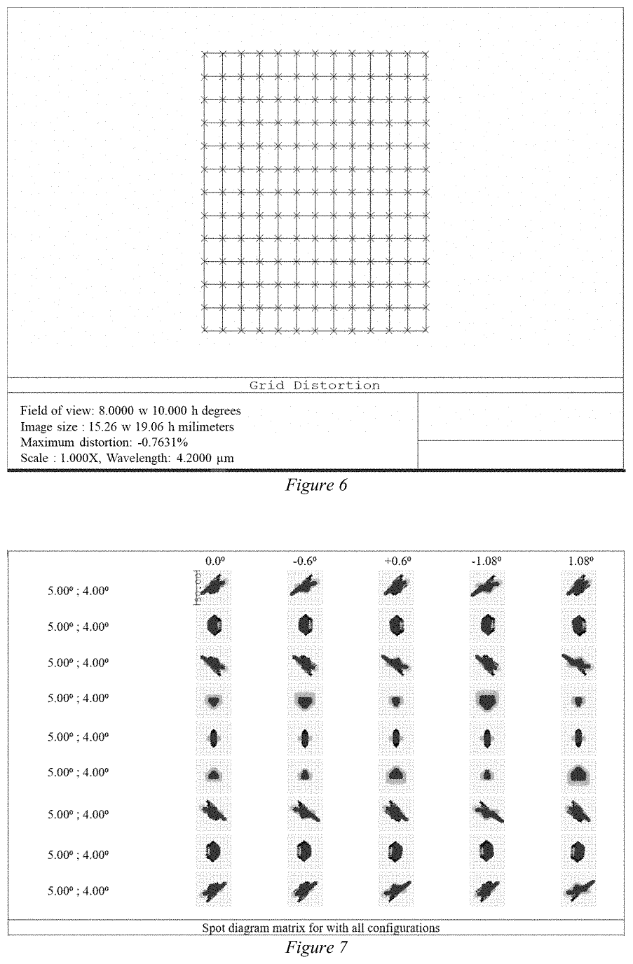

Referring to FIG. 4, FIG. 5, FIG. 6, the design has been optimized to achieve good image quality with every configuration when the mirror is not rotating. The optimized spot sizes are all smaller than 15 μm at every position on the sensor, ensuring an image size of at least 12.3 mm, which corresponds to a resolution of 1280×1024 pixels (HD). FIG. 5 and FIG. 6 show that the modulation transfer function has been optimized to achieve good quality, close to the diffraction limit at all positions while the distortion is minimized by less than 1%.

Referring to FIG. 7, the design has been optimized so that when the mirror (M1) rotates at different angles to compensate for the rotation angle of the lens, the image corresponding to each individual position of the mirror always maintains its sharpness. FIG. 7 shows that the RMS spot radius at all locations on the image plane with mirror rotations to be less than 15 μm at all locations on the sensor.

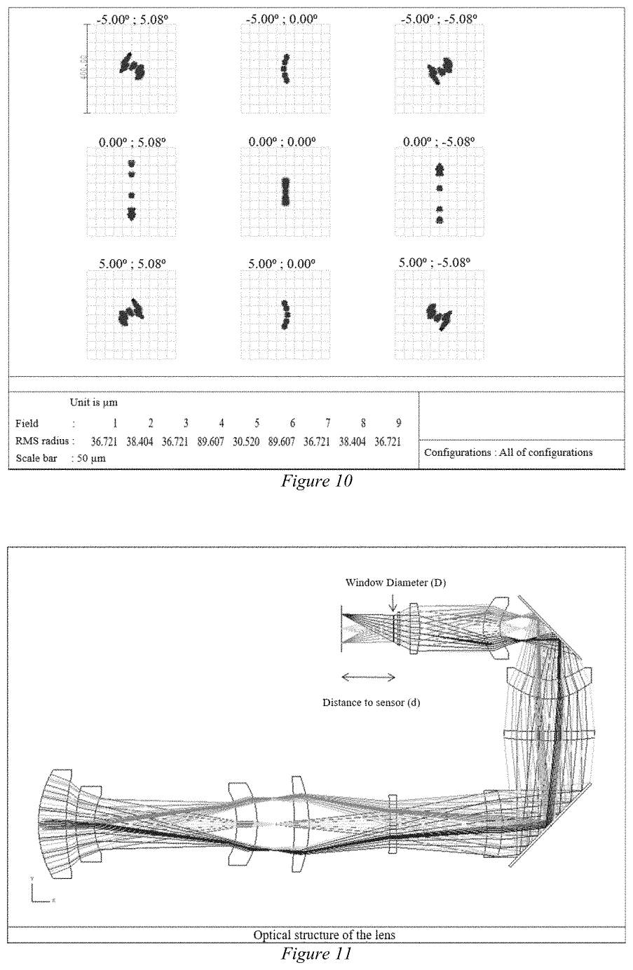

Referring to FIG. 9, FIG. 10, the design has been optimized so that when the mirror (M1) rotates, the image position corresponding to each field point remains the same, ensuring that during the entire operation the image is always sharp. FIG. 9 depicts the spot size calculated with all angles on the same frame of reference for all fields on the sensor; FIG. 9 shows that the overall RMS spot radius at all rotation angles is less than 15 μm, indicating that the image location of each field point is not deviated from the original position. FIG. 10 describes the spot radius of each field point in case the lens is not optimized for image wander reduction; FIG. 10 shows that the overall RMS spot radius is much larger than the pixel size, in addition, it can be visually seen that the image positions corresponding to each different rotation angle are located in different locations. Thus, the lens has been designed to ensure that the image position of each field is kept within the boundary of each pixel.

According to this structure, the invention of an anti-blur infrared lens for a panoramic camera system using an HD resolution sensor is designed to satisfy the following conditions:

$$\{ \begin{matrix}1.2 \leq f ( L 1 , L 2 , L 3 ) / f ( L4 , L 5 , L 6 ) \leq 2.0 \\ 1.1 \leq f ( G 1 , G 2 , G 3 ) / f ( G 1 , G 2 ) \leq 2.5 \\ 1 . {8}^{0} \leq β \\ d / D < 2\end{matrix}$$

In which:

f(L1,L2,L3) is the focal length of the optical part formed by the lenses (L1), (L2), (L3);

f(L4,L5,L6) is the focal length of the optical part formed by the lenses (L4), (L5), (L6);

f(G1,G2,G3) is the focal length of the optical part formed groups (G1), (G2), (G3);

f(G1,G2) is the focal length of the optical part formed by the groups (G1), (G2);

β is the rotation angle of the device each time it takes one frame;

d is the distance from exit pupil to image plane;

D is the diameter of the exit pupil of the lens.

An example is made for the invention of an anti-blur infrared lens for a panoramic camera system using an HD resolution sensor 1280×1024 F/#2 sensors, with detailed parameters are as follows:

TABLE 1

| | | Radius of | | |
|---|---|---|---|---|
| No. | Surface type | curvature | Thickness | Material |
| 1 | Spherical | 55.55 | 14.91 | Silicon |
| 2 | Aspherical | 118.44 | 5.39 | |
| 3 | Aspherical | 75.84 | 9.91 | Germanium |
| 4 | Aspherical | 33.96 | 76.96 | |
| 5 | Aspherical | −47.25 | 11.00 | Germanium |
| 6 | Extended polynomial | −44.58 | 20.00 | |
| 7 | Extended polynomial | −331.64 | 8.00 | ZnSe |
| 8 | Spherical | −69.98 | 43.79 | |
| 9 | Aspherical | −218.83 | 3.50 | Germanium |
| 10 | Aspherical | −807.21 | 49.02 | |
| 11 | Spherical | −79.12 | 8.00 | Silicon |
| 12 | Spherical | −63.50 | 25.50 | |
| 13 | Plane | | −42.20 | Mirror |
| 13 | Diffractive | −297.42 | −4.57 | Germanium |
| 14 | Spherical | −404.39 | −17.23 | |
| 15 | Aspherical | −28.32 | −10.01 | Silicon |
| 16 | Aspherical | −25.21 | −27.21 | |
| 17 | Plane | | 26.50 | Mirror |
| 18 | Aspherical | −18.54 | 9.17 | Germanium |
| 19 | Diffractive | −22.10 | 34.35 | |
| 20 | Aspherical | 60.49 | 5.10 | Silicon |
| 21 | Aspherical | 1887.42 | | |

The unit of measure used in the tables is ‘mm’

The aspherical surfaces are defined by the following formula:

$$z = \frac{\frac{1}{R} {y}^{2}}{1 + \sqrt{1 - ( 1 + k ) \frac{1}{{R}^{2}} {y}^{2}}} + {\sum }_{i = 1}^{n} {A}_{2 i} {y}^{2 i}$$

In which:

R is the radius of curvature of the aspherical surface

y is the axial height from the optical axis

k is the conic constant of the aspherical surface

A₂ᵢ are respectively the even order aspherical coefficients of 2, 4, 6, 8,10, 12, . . .

The table below lists the aspherical parameters of some lens surfaces:

TABLE 2

| Surface | Conic | A4 | A6 | A8 | A10 |
|---|---|---|---|---|---|
| 2 | | 7.328e−7 | −2.500e−10 | 9.839e−14 | −1.980e−17 |
| 3 | | 8.393e−7 | −1.355e−10 | 9.406e−14 | −9.804e−17 |
| 4 | | 8.223e−6 | 1.309e−9 | 1.727e−12 | 2.924e−16 |
| 5 | | −9.755e−6 | −6.764e−9 | −3.271e−12 | |
| 9 | | −8.236e−7 | −2.829e−9 | −2.640e−12 | 4.495e−16 |
| 10 | | −6.667e−7 | −1.944e−9 | −2.859e−12 | 2.740e−15 |
| 14 | | −1.164e−6 | 7.962e−10 | −5.056e−13 | 2.144e−16 |
| 16 | | 4.326e−6 | 7.200e−9 | 4.918e−12 | 6.318e−15 |
| 17 | | 7.237e−6 | 2.657e−8 | 9.476e−13 | 2.034e−15 |
| 19 | | −7.873e−6 | 3.356e−8 | 1.358e−9 | −2.936e−12 |
| 20 | | 1.169e−6 | 1.462e−8 | 2.943e−11 | 1.994e−13 |
| 21 | | −3.269e−6 | 2.327e−8 | −1.710e11 | 4.535e14 |
| 22 | | −2.721e6 | 3.304e−8 | −4.688e−11 | 8.700e−14 |

The diffractive surfaces used in the design are described by the following polynomial expansion:

$$Φ = M {\sum }_{i = 1}^{n} {A}_{i} {ρ}^{2 i}$$

In which:

Φ is the phase added to the ray at the coordinates defined by ρ,

Aᵢ are the coefficients of the polynomial that are optimized during the design process.

ρ là the normalized coordinate at the diffractive surface.

The table below lists the diffraction coefficients at the S14 and S20 surfaces:

TABLE 3

| | S14 | S20 |
|---|---|---|
| A₁ | −9.5986e−5 | −1.3571e−4 |
| A₂ | 8.6280e−10 | −5.6461e−8 |

The extended polynomial surfaces are defined by the following polynomial:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y )$$

In which:

z is the sag at the calculated point

k is the conic constant of the surface

c is the curvature of the surface

r is the radius at coordinates x,y

N is the number of coefficients of the polynomial

Aᵢ is the coefficient corresponding to the monomial of order i

Ei(x,y) is the monomial of x and y corresponding to order i

The following table lists the coefficients corresponding to the respective monomials of the surfaces S6 and S7:

TABLE 4

Coefficient

| Monomial | S6 | S7 |
|---|---|---|
| X1Y0 | 0.000E+00 | 0.000E+00 |
| X0Y1 | −1.543E−03 | 2.834E−03 |
| X2Y0 | 7.210E−01 | −1.160E−01 |
| X1Y1 | 0.000E+00 | 0.000E+00 |
| X0Y2 | 6.680E−01 | −2.600E−02 |
| X3Y0 | 0.000E+00 | 0.000E+00 |
| X2Y1 | 7.511E−04 | −4.387E−03 |
| X1Y2 | 0.000E+00 | 0.000E+00 |
| X0Y3 | −2.163E−04 | 2.907E−03 |
| X4Y0 | −1.222E+00 | −2.440E−01 |
| X3Y1 | 0.000E+00 | 0.000E+00 |
| X2Y2 | −2.466E+00 | −5.280E−01 |
| X1Y3 | 0.000E+00 | 0.000E+00 |
| X0Y4 | −1.257E+00 | −1.270E−01 |

The detailed description of this invention has been specifically explained above, however it should also be understood that the descriptions presented are merely a model of the invention, it can be expressed in many different forms. Therefore, the details of the parameters presented here should not be considered as a limitation, they are only the basis for other proposals.

1. An anti-blur infrared lens for panoramic camera system using HD resolution sensor with folding structure consists of ten main lenses and two reflectors, one of reflector is a fast steering mirror; in a direction from an object plane to an image plane, the lens consists of:
lenses (L1), (L2), (L3), (L4), (L5), (L6) forming an outermost angular magnification lens group (G1);
a fast steering mirror group (M1);
lenses (L7), (L8) forming a converging lens group (G2);
a fixed mirror group (M2); and
lenses (L9), (L10) forming an intermediate image magnification lens group (G3).

2. The anti-blur infrared lens for panoramic camera system using HD resolution sensor, according to claim 1, wherein in the direction from the object plane to the image plane, the magnification group (G1) includes 6 single lens elements; in which:
three lenses (L1),(L2),(L3) including two positive power lenses combined with negative power (L3) lens are responsible for receiving incident parallel light beams and focusing them at an intermediate image plane; a focal length of the optical part generated by these three lenses satisfies 200 mm>f(L1,L2,L3)>150 mm;
the next three lenses of the magnification group (G1) are (L4), (L5), (L6) consisting of two positive power lenses (L4, L6) combined with one negative power lens (L5) to convert an intermediate image into parallel beams; a focal length of the optical part created by these three lenses satisfies 100 mm<f(L4,L5,L6)<150 mm; group (G1) has the effect of magnifying a focal length of the optical part created by groups (G2,G3) to a ratio (A), this magnification ratio satisfies 1.2≤f(L1,L2,L3)/f(L4,L5,L6)=A≤2.0.

3. The anti-blur infrared lens for panoramic camera system using HD resolution sensor, according to claim 1, wherein in the direction from the object plane to the image plane, the lenses (L3), (L4) are those with anti-blur effect when scanning; in which:
lens (L3) is made of germanium with negative power, consisting of a concave surface (S5) with an aspherical profile and a convex surface (S6) with extended polynomial profile;
lens (L4) is made of zinc selenide with negative power, consisting of a concave surface (S7) with an extended polynomial profile and a surface (S8) with a spherical profile with the convex face towards the image plane;
surfaces of the lenses (L3), (L4) are optimized so that when the fast steering mirror group (M1) rotates, an image point position corresponding to each field of view remains the same, ensuring an overall spot size of the lens is always smaller than a pixel pitch when the mirror group rotates continuously.

4. The anti-blur infrared lens for panoramic camera system using HD resolution sensor, according to claim 1, wherein in the direction from the object plane to the image plane, using a fast steering mirror group (M1) located in an exit pupil position of the magnification group (G1) between the lenses (L6) and (L7); the anti-blur infrared lens for panoramic camera system using HD resolution sensor uses a fast steering mirror and is designed to satisfy a compensation of rotation angle and meets:
$$\{ \begin{matrix}α = β \times A / 2 \\ 1 . {8}^{0} \leq β\end{matrix}$$
in which α is a rotation angle of the mirror, β is a maximum rotation angle of the device in an integration time for each frame, A is a magnification ratio of the group (G1); corresponding to each separate position of the mirror group satisfying the above equation, the image always maintains its sharpness, a spot radius at all positions on the sensor at every rotation angle of the mirror group are smaller than a pixel pitch of the sensor.

5. The anti-blur infrared lens for panoramic camera system using HD resolution sensor, according to claim 1, wherein in the direction from the object plane to the image plane, converging lens group (G2) consisting of two lenses positive focal lengths (L7), (L8) focus a light beam coming out of the group (G1) to create an intermediate image plane; single lens element (L8) which helps the lens have focus ability in different distance and temperature, is made of silicon, with positive power, and two curved surfaces of aspherical profile, the focus group helps the lens compensate the image sharpness at a distance from 20 m to infinity in a temperature range from −20° C. to 65° C.

6. The anti-blur infrared lens for panoramic camera system using HD resolution sensor, according to claim 1, wherein in the direction from the object plane to the image plane, the reflector (M2) is placed in between the lens elements (L8) and (L9) to create a double fold structure for the lens; a position of the arranged mirror is not on the intermediate image plane.

7. The anti-blur infrared lens for panoramic camera system using HD resolution sensor, according to claim 1, wherein intermediate image magnification group (G3) is designed to magnify an intermediate image created by the convergent lens group (G2); whereby the image magnification ratio is from 1.1 to 2.5, equivalent to 1.1≤|f(G1,G2,G3)/f(G1,G2)|≤2.5.

8. The anti-blur infrared lens for panoramic camera system using HD resolution sensor, according to claim 5, wherein intermediate image magnification group (G3) is designed to magnify an intermediate image created by the convergent lens group (G2); whereby the image magnification ratio is from 1.1 to 2.5, equivalent to 1.1≤|f(G1,G2,G3)/f(G1,G2)|≤2.5.

9. The anti-blur infrared lens for the panoramic camera system using the HD resolution sensor, according to claim 1, optimized so that an exit pupil with diameter D is located directly in front of the sensor with a distance d; whereby the ratio between distance d and diameter D has a value d/D<2, ensuring that the lens is compatible with F/#2 detectors.

10. The anti-blur infrared lens for panoramic camera system using HD resolution sensor, according to the points from claim 1, is designed to satisfy the following conditions:
$$\{ \begin{matrix}1.2 \leq f ( L 1 , L 2 , L 3 ) / f ( L4 , L 5 , L 6 ) \leq 2.0 \\ 1.1 \leq f ( G 1 , G 2 , G 3 ) / f ( G 1 , G 2 ) \leq 2.5 \\ 1 . {8}^{0} \leq β \\ d / D < 2\end{matrix}$$
In which:
f(L1,L2,L3) is a focal length of lens group L1,L2,L3;
f(L4,L5,L6) is a focal length of lens group L4,L5,L6;
f(G1,G2,G3) is a focal length of group G1,G2,G3;
f(G1,G2) is a focal length of group G1,G2;
β is a rotation angle of the device per frame;
d is a distance from exit pupil to image plane;
D is an exit pupil diameter of the lens.

11. The anti-blur infrared lens for panoramic camera system using HD resolution sensor, according to claim 1, with a working F-number of 2 has detailed parameters as shown in the table below:

| | | Radius of | | |
|---|---|---|---|---|
| No. | Surface type | curvature | Thickness | Material |
| 1 | Spherical | 55.55 | 14.91 | Silicon |
| 2 | Aspherical | 118.44 | 5.39 | |
| 3 | Aspherical | 75.84 | 9.91 | Germanium |
| 4 | Aspherical | 33.96 | 76.96 | |
| 5 | Aspherical | −47.25 | 11.00 | Germanium |
| 6 | Extended polynomial | −44.58 | 20.00 | |
| 7 | Extended polynomial | −331.64 | 8.00 | ZnSe |
| 8 | Spherical | −69.98 | 43.79 | |
| 9 | Aspherical | −218.83 | 3.50 | Germanium |
| 10 | Aspherical | −807.21 | 49.02 | |
| 11 | Spherical | −79.12 | 8.00 | Silicon |
| 12 | Spherical | −63.50 | 25.50 | |
| 13 | Plane | | −42.20 | Mirror |
| 13 | Diffractive | −297.42 | −4.57 | Germanium |
| 14 | Spherical | −404.39 | −17.23 | |
| 15 | Aspherical | −28.32 | −10.01 | Silicon |
| 16 | Aspherical | −25.21 | −27.21 | |
| 17 | Plane | | 26.50 | Mirror |
| 18 | Aspherical | −18.54 | 9.17 | Germanium |
| 19 | Diffractive | −22.10 | 34.35 | |
| 20 | Aspherical | 60.49 | 5.10 | Silicon |
| 21 | Aspherical | 1887.42 | | |

The unit of measurement used in the tables is “mm”;
The aspherical surfaces are defined by the following polynomial:
$$z = \frac{\frac{1}{R} {y}^{2}}{1 + \sqrt{1 - ( 1 + k ) \frac{1}{{R}^{2}} {y}^{2}}} + {\sum }_{i = 1}^{n} {A}_{2 i} {y}^{2 i}$$
In which:
R is a radius of curvature of the aspherical surface;
y is an axial height from the optical axis;
k is a conic constant of the aspherical surface;
A₂ᵢ are respectively even order aspherical coefficients of 2, 4, 6, 8,10, 12, . . .
The table below lists the aspherical parameters of some lens surfaces:

| | Conic | | | | |
|---|---|---|---|---|---|
| Surface | constant | A4 | A6 | A8 | A10 |
| 2 | | 7.328e−7 | −2.500e−10 | 9.839e−14 | −1.980e−17 |
| 3 | | 8.393e−7 | −1.355e−10 | 9.406e−14 | −9.804e−17 |
| 4 | | 8.223e−6 | 1.309e−9 | 1.727e−12 | 2.924e−16 |
| 5 | | −9.755e−6 | −6.764e−9 | −3.271e−12 | |
| 9 | | −8.236e−7 | −2.829e−9 | −2.640e−12 | 4.495e−16 |
| 10 | | −6.667e−7 | −1.944e−9 | −2.859e−12 | 2.740e−15 |
| 14 | | −1.164e−6 | 7.962e−10 | −5.056e−13 | 2.144e−16 |
| 16 | | 4.326e−6 | 7.200e−9 | 4.918e−12 | 6.318e−15 |
| 17 | | 7.237e−6 | 2.657e−8 | 9.476e−13 | 2.034e−15 |
| 19 | | −7.873e−6 | 3.356e−8 | 1.358e−9 | −2.936e−12 |
| 20 | | 1.169e−6 | 1.462e−8 | 2.943e−11 | 1.994e−13 |
| 21 | | −3.269e−6 | 2.327e−8 | −1.710e11 | 4.535e14 |
| 22 | | −2.721e6 | 3.304e−8 | −4.688e−11 | 8.700e−14 |

The diffraction surfaces used in the design are described by the following polynomial expansion:
$$Φ = M {\sum }_{i = 1}^{n} {A}_{i} {ρ}^{2 i}$$
In which:
Φ is a phase added to the ray at the coordinates defined by ρ,
Aᵢ coefficients of the polynomial that is optimized during a design process,
ρ is a normalized coordinate at a diffractive surface,
The table below lists the diffraction coefficients at the S14 and S20 surfaces,

| | S14 | S20 |
|---|---|---|
| A₁ | −9.5986e−5 | −1.3571e−4 |
| A₂ | 8.6280e−10 | −5.6461e−8 |

The extended polynomial surfaces are defined by the following polynomial:
$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y )$$
In which:
z is a sag at the calculated point;
k is a conic coefficient of the surface;
c is a curvature of the surface;
r is a radius at coordinates x,y;
N is a number of coefficients of the polynomial;
Aᵢ is a coefficient corresponding to the monomial of order i;
Eᵢ(x,y) are monomials of x and y corresponding to order i;
The table below lists the coefficients corresponding to the respective monomials of the surfaces S6 and S7.
Coefficients

| Monomial | S6 | S7 |
|---|---|---|
| X1Y0 | 0.000E+00 | 0.000E+00 |
| X0Y1 | −1.543E−03 | 2.834E−03 |
| X2Y0 | 7.210E−01 | −1.160E−01 |
| X1Y1 | 0.000E+00 | 0.000E+00 |
| X0Y2 | 6.680E−01 | −2.600E−02 |
| X3Y0 | 0.000E+00 | 0.000E+00 |
| X2Y1 | 7.511E−04 | −4.387E−03 |
| X1Y2 | 0.000E+00 | 0.000E+00 |
| X0Y3 | −2.163E−04 | 2.907E−03 |
| X4Y0 | −1.222E+00 | −2.440E−01 |
| X3Y1 | 0.000E+00 | 0.000E+00 |
| X2Y2 | −2.466E+00 | −5.280E−01 |
| X1Y3 | 0.000E+00 | 0.000E+00 |
| X0Y4 | −1.257E+00 | −1.270E−01. |
